(19) United States
(12) Patent Application Publication
(10) Pub. No.: US 2026/0365102 A1
(43) Pub. Date: Nov. 19, 2026

(54) Warning Sign Device

(71) Applicant: Ida Mollo, New Orleans, LA (US)

(72) Inventor: Ida Mollo, New Orleans, LA (US)

(21) Appl. No.: 19/737,422

(22) Filed: Jul. 10, 2026

(51) Int. Cl. B60Q 1/50; G09F 21/04

(52) U.S. Cl. CPC B60Q 1/543; G09F 21/041; B60Q 2400/20

(57) ABSTRACT

A warning sign device includes a tubular body formed of a plurality of interlaced polymeric strands defining a braided reinforcement pattern forming a structurally reinforced, flexible tubular wall. The tubular body is configured in an arrow shape having a shaft portion and one or more arrowhead portions and includes an attachment assembly configured to detachably secure the device to a surface of a vehicle. A plurality of light emitting elements is disposed within the tubular body and arranged to form a directional arrow pattern visible through the tubular body. The device further includes a power source and a control assembly electrically connected to the light emitting elements for selectively energizing the light emitting elements to provide illuminated directional indications that alert approaching traffic to the presence of a stopped or disabled vehicle and guide the drivers to take a different direction.

### BACKGROUND OF THE INVENTION

### Field of the Invention

The present invention relates generally to warning signs, and more particularly to a warning sign device magnetically attachable to a vehicle surface.

### Description of the Related Art

Conventional vehicle warning systems are used when a vehicle is stopped or disabled on a roadway. The warning systems are intended to warn approaching drivers of the vehicle's presence so that the drivers can slow down or change direction.

However, such warning systems often include rigid arrow boards, or permanently mounted lighting assemblies. The installation of conventional warning systems is often complex and time-consuming.

Many warning systems require permanent mounting brackets, wiring modifications, or drilling into the vehicle body. This permanent modification not only increases installation cost but also discourages temporary or occasional use. As a result, the conventional warning systems are generally limited to commercial or emergency vehicles rather than everyday passenger vehicles.

Rigid arrow boards and panel-type warning signs also occupy substantial storage space within a vehicle. The bulk and rigidity of such devices make them impractical to carry in ordinary passenger vehicles, where trunk and cabin space is limited. Consequently, many drivers do not carry any illuminated warning equipment at all.

Permanently mounted lighting assemblies present additional drawbacks. Such assemblies typically draw electrical power from the vehicle electrical system and therefore require professional installation, dedicated wiring, and ongoing maintenance. The associated expense further limits such systems to commercial fleets and emergency vehicles.

Portable warning signs are available as an alternative, but they introduce a different set of challenges. Many portable signs are non-illuminated, which significantly reduces their visibility during nighttime, fog, rain, or other low-light conditions.

Non-illuminated portable signs, including reflective triangles and panels, depend upon the headlights of approaching vehicles to be seen. When an approaching vehicle is positioned at an unfavorable angle, or when ambient conditions scatter or obscure reflected light, such passive devices provide little or no warning to approaching drivers.

Other portable warning devices rely on external mounting mechanisms such as stands, hooks, or suction cups. These mounting mechanisms may be unstable, difficult to deploy quickly, or ineffective on curved or uneven vehicle surfaces.

For example, freestanding stands may be displaced by wind or by air currents generated by passing traffic. Hooks require a compatible edge or lip on the vehicle body and cannot be repositioned freely. Suction cups lose holding force on textured, dirty, or wet surfaces and are poorly suited to the curved body panels found on most vehicles.

In addition, many existing portable warning devices are constructed from rigid materials. The lack of flexibility makes such devices prone to breakage during impact, handling, or storage. Because of these limitations, drivers are often left without a reliable, easy-to-use warning solution during roadside emergencies.

A need exists for a warning sign device that can be detachably attached to a vehicle without permanent mounting brackets, wiring modifications, or drilling into the vehicle body.

A need exists for a warning sign device having a flexible structure that conforms to curved or uneven vehicle surfaces and resists breakage during impact, handling, and storage.

A need exists for a warning sign device that provides illuminated directional indications visible during nighttime, fog, rain, and other low-light conditions.

A need exists for a warning sign device that can be deployed quickly by a single user during a roadside emergency, without tools and without reliance on the vehicle electrical system.

A need exists for a warning sign device that is compact, lightweight, and reusable, such that the device may be conveniently stored within an everyday passenger vehicle between uses.

The present invention addresses these needs by providing a warning sign device that is flexible, illuminated, and magnetically attachable to a vehicle surface. As disclosed in this application, the inventor has discovered a novel warning sign device that is detachably attachable to a vehicle or other structure. The disclosed device exhibits improved visibility, portability, and ease of deployment without requiring vehicle modification or complex mounting systems for attachment to vehicles.

Embodiments of the present invention provide warning sign devices as disclosed herein and as defined in the annexed claims, which provide for improved visual alerting of approaching traffic. The warning sign device is configured to emit light to provide directional indications to draw attention to a stopped or disabled vehicle and to guide approaching drivers to take an alternate direction.

Embodiments of the present invention further provide flexible, tubular warning sign bodies and attachment assemblies as defined in the annexed claims, which enable secure detachable attachment to curved vehicle surfaces. The flexible structure, illuminated arrow configuration, and removable attachment features collectively improve deployment speed, safety, and reusability in roadside and emergency situations.

### SUMMARY OF THE INVENTION

The following presents a simplified summary of the present disclosure in a simplified form as a prelude to the more detailed description that is presented herein.

Therefore, in accordance with embodiments of the invention, there is provided a warning sign device, also referred to herein as a warning arrow sign device, configured to be detachably attached to a surface of a vehicle. The warning sign device is configured to emit light in the form of illuminated directional indications to draw attention to a stopped or disabled vehicle and to guide approaching drivers to take a different direction.

It is one aspect of the present invention to provide one or more novel warning sign devices of simple yet effective construction that can be deployed in roadside and vehicle-related environments to visibly alert approaching traffic and provide illuminated directional guidance.

In accordance with embodiments of the invention, the warning sign device comprises a hollow cylindrical body formed of braided vinyl tubing. The braided vinyl tubing comprises a plurality of interlaced polymeric strands defining a braided reinforcement pattern forming a tubular wall. The braided construction provides a technical improvement over conventional rigid warning devices because the interlaced polymeric strands cooperate to provide structural reinforcement while permitting the tubular wall to flex and conform to a mounting surface.

In one embodiment, the plurality of interlaced polymeric strands are heat-fused at interstitial crossing points to enhance rigidity. The heat-fused crossing points stabilize the braided reinforcement pattern so that the warning sign device retains its arrow shape during handling and deployment while remaining resiliently flexible.

The warning sign device further comprises an array of light emitting diodes disposed within a lumen of the hollow cylindrical body. Positioning the array of light emitting diodes within the lumen protects the light emitting diodes from impact, weather, and handling damage while permitting emitted light to pass outwardly through the braided vinyl tubing.

The warning sign device further comprises a plurality of magnets secured along an interior longitudinal surface of the tubular wall of the hollow cylindrical body for removable magnetic attachment of the warning sign device to a metallic surface of a vehicle. The magnetic attachment enables tool-free deployment and removal without permanent modification of the vehicle.

In one embodiment, the magnets comprise neodymium magnets spaced along one side of the hollow cylindrical body. Spacing the neodymium magnets along one side distributes the attachment force along the length of the warning sign device and permits the flexible body to conform to curved vehicle surfaces while remaining securely attached.

In one embodiment, the braided reinforcement pattern comprises a cross-stitch configuration oriented helically about the tubular wall. The helical cross-stitch configuration distributes bending loads about the tubular wall and contributes to the structural integrity of the warning sign device.

In one embodiment, the hollow cylindrical body is resiliently flexible to conform to a curved surface of the vehicle. In one embodiment, the hollow cylindrical body comprises transparent or translucent braided vinyl to permit outward illumination of the light emitting diodes.

In one embodiment, the hollow cylindrical body further defines an elongated arrow shaft portion terminating in an arrowhead portion. The arrowhead portion is also formed of the braided vinyl tubing, such that the entire arrow shape shares the flexible, reinforced braided construction.

In accordance with further embodiments of the invention, a warning sign device comprises a hollow braided tubular body comprising a plurality of interwoven vinyl strands defining a flexible wall. In one embodiment, the hollow braided tubular body is formed as a single continuous piece defining both an arrow shaft portion and an arrowhead portion. Forming the hollow braided tubular body as a single continuous piece eliminates joints and fasteners that could fail during flexing of the warning sign device.

In one embodiment, the braided vinyl wall includes at least two different polymeric strand diameters to define a textured reinforcement pattern. The textured reinforcement pattern varies the wall structure of the hollow braided tubular body and contributes to the reinforcement of the flexible wall.

The warning sign device further comprises a plurality of light emitting diodes disposed within the hollow braided tubular body and arranged in a directional arrow pattern visible through openings defined by the braided vinyl strands. The openings defined between the interwoven vinyl strands permit direct outward passage of emitted light, thereby improving the visibility of the directional arrow pattern to approaching drivers.

In one embodiment, the plurality of light emitting diodes is sequentially addressable to generate a moving arrow illumination effect. The moving arrow illumination effect provides a dynamic directional indication that draws the attention of approaching drivers and visually communicates the direction in which the approaching drivers should travel.

In one embodiment, the plurality of light emitting diodes is embedded along an interior support strip extending within the hollow braided tubular body. The interior support strip maintains the alignment and spacing of the light emitting diodes within the hollow braided tubular body during bending and handling of the warning sign device.

The warning sign device further comprises a power source electrically coupled to the plurality of light emitting diodes. In one embodiment, the power source is housed within a compartment integrated into the hollow braided tubular body, such that the warning sign device operates independently of the vehicle electrical system.

The warning sign device further comprises a magnet array disposed along a first side of the hollow braided tubular body to facilitate removable magnetic attachment of the warning sign device to a metallic surface of a vehicle. In one embodiment, the magnet array is positioned opposite the illuminated direction of the plurality of light emitting diodes, such that the light emitting diodes face outwardly toward approaching traffic while the magnet array engages the vehicle.

In accordance with yet further embodiments of the invention, a warning sign device comprises a hollow cylindrical body comprising braided vinyl tubing having a lumen. In one embodiment, the hollow cylindrical body comprises a diameter between 1.0 cm and 5.0 cm. Further, the hollow cylindrical body is bendable into a curved arrow shape while maintaining the structural integrity of the braided vinyl strands.

The warning sign device further comprises a plurality of light emitting diodes disposed within the lumen of the braided vinyl tubing, and a battery electrically connected to the plurality of light emitting diodes. In one embodiment, the battery comprises a rechargeable lithium-ion cell positioned within the hollow cylindrical body. The rechargeable lithium-ion cell permits repeated reuse of the warning sign device without replacement of the battery.

The warning sign device further comprises a switch electrically interposed between the battery and the plurality of light emitting diodes for selectively energizing the plurality of light emitting diodes. In one embodiment, the switch comprises a manual toggle switch mounted externally on the hollow cylindrical body, permitting the user to energize the plurality of light emitting diodes immediately upon deployment.

In one embodiment, the switch comprises a pressure-sensitive switch configured to energize the plurality of light emitting diodes upon magnetic attachment of the hollow cylindrical body to the metallic surface. The pressure-sensitive switch provides automatic activation of the warning sign device upon attachment, reducing deployment time during a roadside emergency.

The warning sign device further comprises a plurality of magnets affixed along a longitudinal side of the hollow cylindrical body for removably securing the warning sign device to a metallic surface of a vehicle. In one embodiment, the plurality of magnets is recessed within magnet housings secured to the braided vinyl tubing. Recessing the plurality of magnets within the magnet housings protects the magnets and presents a substantially uniform attachment side.

The embodiments disclosed herein provide practical applications and technical improvements in the field of vehicle warning devices, including a flexible braided tubular construction that conforms to curved vehicle surfaces, illuminated directional indications visible in low-light conditions, tool-free magnetic attachment without vehicle modification, and rapid, reusable deployment during roadside emergencies.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which like numerals throughout the figures identify substantially similar components, in which:

FIG. 1 is a warning sign device attached to a tailgate of a vehicle, in accordance with embodiments of the invention;

FIG. 2 is the warning sign device securely attached to a different portion of the vehicle of FIG. 1, in accordance with embodiments of the invention;

FIG. 3 is a warning sign device attached to a vehicle and having at least two arrowheads oriented in opposing directions, in accordance with embodiments of the invention;

FIG. 4 is a block diagram of the warning sign device, in accordance with embodiments of the invention;

FIG. 5 is a top view of the warning sign device, in accordance with embodiments of the invention;

FIG. 6 is a portion of the warning sign device, in accordance with embodiments of the invention;

FIG. 7 is a bottom view of the warning sign device, in accordance with embodiments of the invention;

FIG. 8 is a side view of the warning sign device comprising a support strip embedded with light emitting diodes emitting light, in accordance with embodiments of the invention; and

FIG. 9 is another side view of the warning sign device comprising a control assembly, a power source and an attachment assembly, in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

As used herein, “axis” means a real or imaginary straight line about which a three-dimensional body is symmetrical. A “vertical axis” means an axis perpendicular to the ground (or put another way, an axis extending upwardly and downwardly). A “horizontal axis” means an axis parallel to the ground.

As used herein, homogeneous is defined as the same in all locations, and a homogeneous material is a material of uniform composition throughout that cannot be mechanically separated into different materials. Examples of “homogeneous materials” are certain types of plastics, ceramics, metals, alloys, paper, board, resins, high-density polyethylene and rubber.

Reference will now be made in detail to the present preferred embodiments of the invention, examples of which are illustrated in the accompanying drawings. Wherever possible, the same reference numerals are used in the drawings and the description to refer to the same or like parts.

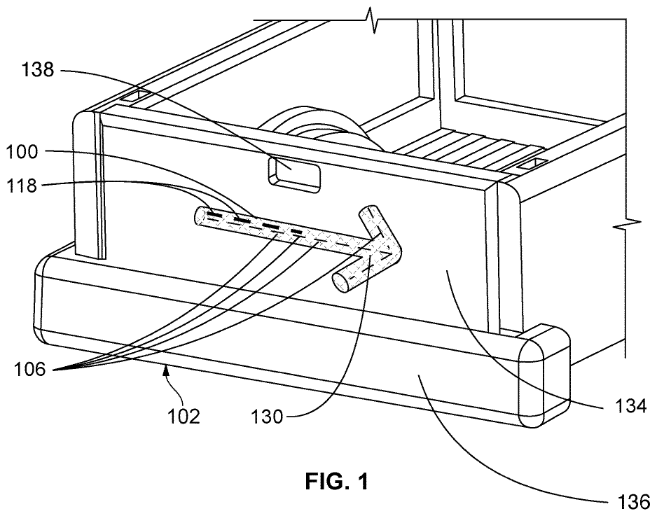

Referring to FIG. 1 to FIG. 3, a warning sign device 100 is configured to be detachably attached to a surface of a structure, for example, a vehicle 102. The warning sign device 100 is configured to illuminate to bring attention to the vehicle 102. The warning sign device 100 is further configured to provide a visual indication to alert approaching traffic to take a different direction.

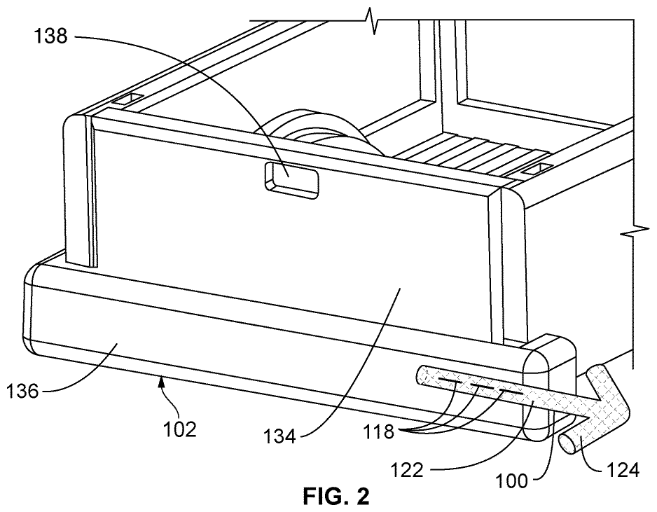

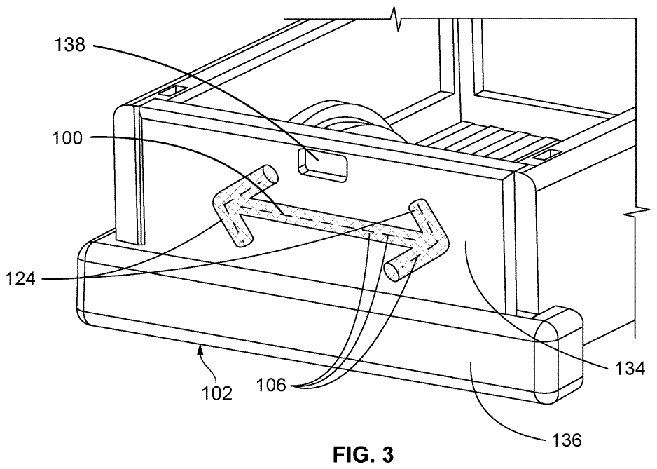

The warning sign device 100 is configured to be detachably attached to a metallic surface of the vehicle 102, such as a tailgate 134 of the vehicle 102 or a bumper 136 of the vehicle 102. Referring to FIG. 1 and FIG. 3, the tailgate 134 comprises a tailgate release handle 138. The tailgate 134, the bumper 136, and the tailgate release handle 138 are further shown in FIG. 2.

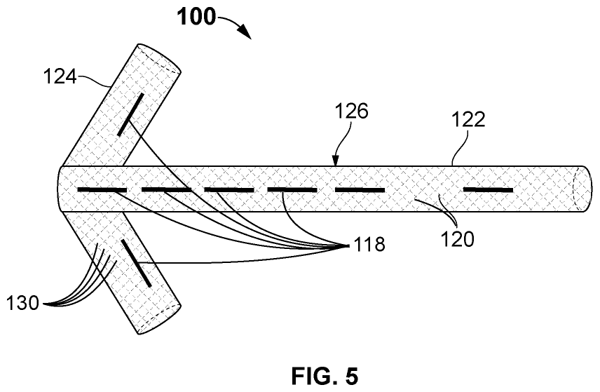

Referring to FIG. 1 and FIG. 2, in one embodiment, the warning sign device 100 comprises a single arrowhead portion 124 (shown in FIG. 5). Referring to FIG. 1, the warning sign device 100 is detachably attached to the tailgate 134 of the vehicle 102.

Referring to FIG. 2, the warning sign device 100 is detachably attached to a different portion of the vehicle 102, for example, the bumper 136 of the vehicle 102.

Referring to FIG. 3, in another embodiment, the warning sign device 100 comprises first and second arrowhead portions 124 disposed at opposite ends of a shaft portion 122 (shown in FIG. 5) and oriented in opposing directions.

It will be understood that the warning sign device 100 may be configured to indicate one or more directions, including left, right, or combinations thereof, and may include any number of arrowhead portions 124. The illustrated configurations are provided by way of example only and are not intended to be limiting.

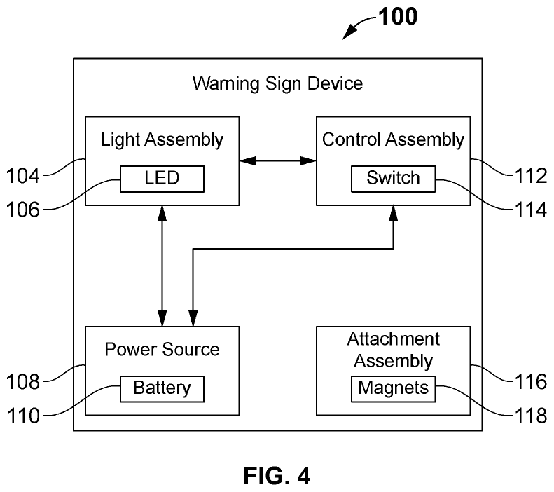

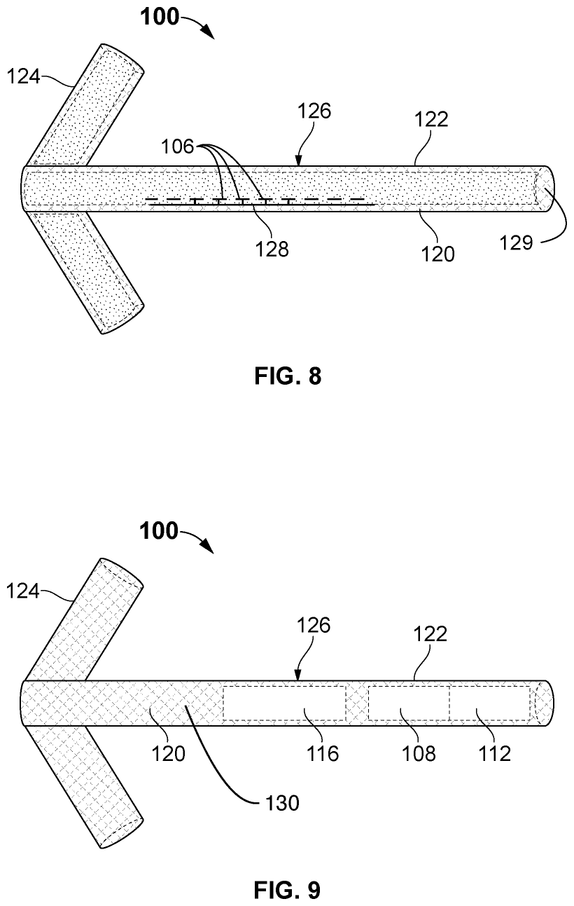

Referring to FIG. 4, FIG. 8, and FIG. 9, the warning sign device 100 comprises a sign body. The sign body is formed of a flexible material configured to bend and conform to a surface of a structure or the vehicle 102.

The warning sign device 100 further comprises a light assembly 104 disposed at the sign body. The light assembly 104 comprises a plurality of light emitting elements arranged along at least a portion of the sign body.

In one embodiment, the light emitting elements are disposed within the sign body. In another embodiment, the light emitting elements are disposed on an exterior surface of the sign body. In yet another embodiment, the light emitting elements are disposed at the exterior surface of the sign body and within the sign body.

The light assembly 104 is configured to emit light to provide a visible directional indication. In one embodiment, the light emitting elements are light emitting diodes 106.

The warning sign device 100 further comprises a power source 108 electrically coupled to the light assembly 104. The power source 108 is configured to supply electrical power to the light assembly 104. The power source 108 is housed within a compartment integrated into the sign body.

In one embodiment, the power source 108 comprises one or more batteries 110. In one embodiment, the battery 110 comprises a rechargeable lithium-ion cell positioned within the sign body or tubular body 126 (shown in FIG. 5).

The warning sign device 100 further comprises a control assembly 112 electrically coupled to the power source 108 and the light assembly 104. The control assembly 112 enables a user to selectively control the illumination of the light assembly 104.

In one embodiment, the control assembly 112 comprises a switch 114 electrically interposed between the battery 110 and the plurality of light emitting diodes 106 for selectively energizing the plurality of light emitting diodes 106.

The warning sign device 100 further comprises an attachment assembly 116 disposed along an exterior side of the sign body. The attachment assembly 116 is configured to detachably secure the warning sign device 100 to a surface. In one embodiment, the attachment assembly 116 comprises a plurality of magnets 118.

Referring to FIG. 5 to FIG. 9, the sign body comprises a hollow tubular body 126. In one embodiment, the warning sign device 100 comprises a plurality of interlaced polymeric strands 120 defining a braided reinforcement pattern forming the tubular body 126.

The braided reinforcement pattern of the plurality of interlaced polymeric strands 120 preferably comprises a cross-stitch configuration extending helically around the tubular body 126. As used herein, the cross-stitch configuration refers to an arrangement in which polymeric strands 120 intersect and overlap one another in a crisscross pattern to form the braided reinforcement pattern.

The polymeric strands 120 intersecting in the cross-stitch configuration are fused to one another at crossing points by application of heat or by any other suitable bonding method. The fusion of the polymeric strands 120 enhances the structural rigidity of the tubular body 126, while allowing the tubular body 126 to remain flexible.

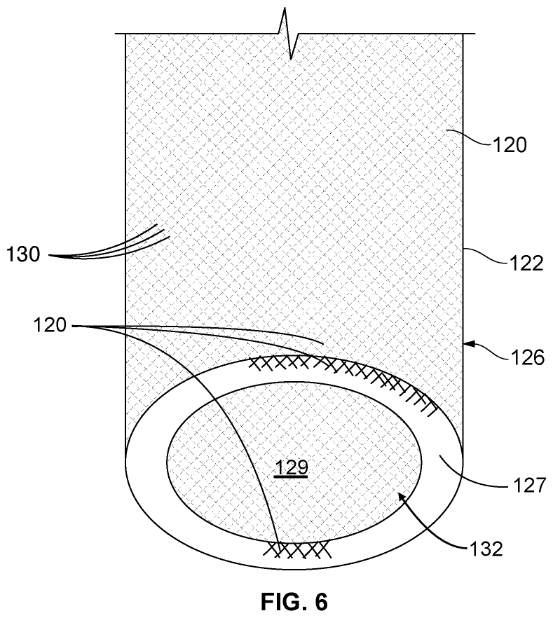

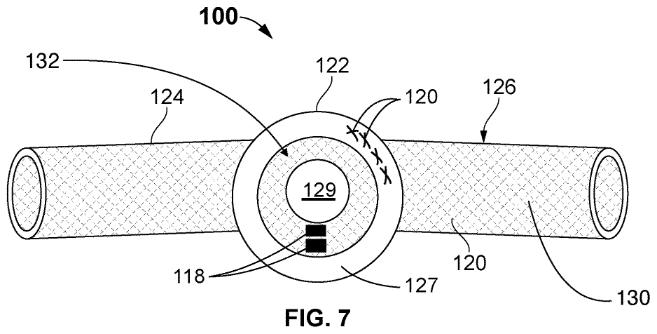

In one embodiment, the tubular body 126 comprises polymeric strands 120 of at least two different diameters to define a textured braided reinforcement pattern. For example, the tubular body 126 comprises a diameter between 1.0 cm and 5.0 cm. In a preferred embodiment, the tubular body 126 is a hollow cylindrical body, as illustrated in FIGS. 6-7.

In one embodiment, the tubular body 126 is resiliently flexible to conform to a curved surface of the vehicle 102. In one embodiment, the plurality of light emitting diodes 106 is disposed within a lumen of the tubular body 126.

In one embodiment, the tubular body 126 is formed of transparent braided vinyl to permit outward illumination of the light emitting diodes 106. In another embodiment, the tubular body 126 is formed of translucent braided vinyl to permit diffused outward illumination of the light emitting diodes 106.

Referring to FIG. 6, the interlaced polymeric strands 120 define a plurality of openings 130 between the interlaced polymeric strands 120. In a preferred embodiment, the plurality of light emitting diodes 106 is arranged in a directional arrow pattern and is visible through the plurality of openings 130 defined by the interlaced polymeric strands 120 within the vinyl tubular body 126. The plurality of openings 130 is further shown in FIG. 5, FIG. 7, and FIG. 9. In another embodiment, the tubular wall 127 of the tubular body 126 is perforated and light is emitted though such perforations in the tubular body 126 in addition to light being emitted through the openings 130. Such perforations also increase the flexibility of the tubular body 126.

In one embodiment, the plurality of light emitting diodes 106 is sequentially addressable to generate a moving arrow illumination effect. The moving arrow illumination effect provides a dynamic directional indication that draws the attention of approaching drivers to the warning sign device 100 and visually communicates the direction in which the approaching drivers should travel.

FIG. 8 exemplarily illustrates a first side of the warning sign device 100 comprising the plurality of light emitting diodes 106. FIG. 9 exemplarily illustrates a second side of the warning sign device 100 comprising one or more components including the power source 108, the control assembly 112, and the attachment assembly 116. The second side is opposite to the first side of the warning sign device 100. The plurality of light emitting diodes 106 is identified in FIG. 4.

Referring to FIG. 8, the warning sign device 100 comprises a support strip 128 disposed at an interior side 132 of the tubular body 126. The tubular body 126 includes a tubular wall 127 and the lumen 129 formed within the tubular wall. The interior side of the tubular body 126 includes at least a portion of the lumen 129 and an interior longitudinal surface 132 of the tubular wall 127. The interior longitudinal surface 132 is shown in FIG. 6 and FIG. 7. In one embodiment, referring to FIG. 7, the lumen 129 extends through the entirety of the shaft portion 122 of the tubular body 126. In such manner, light can be emitted outwardly through each end of the tubular body 126 as well as through the openings 130 of the tubular wall 127, thereby further notifying oncoming traffic.

The plurality of light emitting diodes 106 is embedded within the support strip 128. In one embodiment, the support strip 128 is disposed within the tubular wall of the tubular body 126. In another embodiment, the support strip 128 is disposed within the lumen of the tubular body 126.

Referring to FIG. 9, in one embodiment, the control assembly 112 comprises a manual toggle switch mounted on an external surface of the tubular body 126. The manual toggle switch is electrically connected between the battery 110 and the plurality of light emitting diodes 106 and selectively energizes the plurality of light emitting diodes 106.

In another embodiment, the switch 114 comprises a pressure-sensitive switch configured to energize the plurality of light emitting diodes 106 upon magnetic attachment of the tubular body 126 to the surface. Further, the power source 108 is connected to the control assembly 112.

The plurality of magnets 118 is secured along the interior longitudinal surface 132 of the tubular wall of the tubular body 126. In one embodiment, the magnets 118 are positioned opposite the illuminated direction of the plurality of light emitting diodes 106. The magnets 118 enable detachable attachment of the warning sign device 100 to the metallic surface of the vehicle 102, such as the tailgate 134 or the bumper 136. The plurality of magnets 118 is identified in FIG. 2, FIG. 4, and FIG. 5.

In one embodiment, the magnets 118 comprise neodymium magnets arranged along the second side of the tubular body 126. In one embodiment, the magnets 118 are arranged along a length of the tubular body 126. In one embodiment, the warning sign device 100 comprises a housing formed within the tubular wall of the tubular body 126. The plurality of magnets 118 is disposed within the housing.

Referring to FIG. 5 to FIG. 9, in one embodiment, the sign body or the tubular body 126 is configured in an arrow shape. The tubular body 126 comprises the shaft portion 122 and at least one arrowhead portion 124. The shaft portion 122 and the arrowhead portion 124 are formed from the hollow tubular body 126. The shaft portion 122 comprises a first end portion and a second end portion.

In one embodiment, at least one arrowhead portion 124 is disposed at one end portion of the shaft portion 122. In another embodiment, at least one arrowhead portion 124 is disposed at the first end portion and at least one arrowhead portion 124 is disposed at the second end portion. The tubular body 126 is formed as a single continuous piece defining both the shaft portion 122 and the arrowhead portion 124.

In operation, a user retrieves the warning sign device 100 and positions the warning sign device 100 against the metallic surface of the vehicle 102, such as the tailgate 134 or the bumper 136. The plurality of magnets 118 removably secures the warning sign device 100 to the metallic surface without tools, mounting brackets, wiring modifications, or drilling into the vehicle 102.

The resiliently flexible tubular body 126 bends and conforms to curved or uneven surfaces of the vehicle 102 while the plurality of magnets 118 maintains secure engagement with the metallic surface along the length of the tubular body 126.

The user orients the warning sign device 100 such that the arrowhead portion 124 points in the direction in which approaching drivers should travel. In the embodiment of FIG. 1 and FIG. 2, the single arrowhead portion 124 directs approaching traffic in a single direction. In the embodiment of FIG. 3, the first and second arrowhead portions 124 direct approaching traffic in opposing directions, such that approaching drivers may pass the vehicle 102 on either side.

Upon actuation of the switch 114, the battery 110 energizes the plurality of light emitting diodes 106, and the emitted light passes outwardly through the transparent or translucent tubular body 126 and through the plurality of openings 130, such that the directional arrow pattern is visible to approaching drivers during nighttime, fog, rain, and other low-light conditions. In the embodiment comprising the pressure-sensitive switch, the plurality of light emitting diodes 106 is energized automatically upon magnetic attachment of the warning sign device 100 to the metallic surface.

Following use, the user detaches the warning sign device 100 from the vehicle 102 by pulling the warning sign device 100 away from the metallic surface. The warning sign device 100 is reusable, and the flexible construction of the tubular body 126 permits compact storage of the warning sign device 100 within the vehicle 102 between uses without breakage.

The attachment assembly 116 is not limited to the illustrated magnetic configuration. The attachment assembly 116 comprises any detachable securing mechanism capable of temporarily securing the warning sign device 100 to the surface of the structure or the vehicle 102. Non-limiting examples of the attachment assembly 116 include magnets 118, adhesive elements, fasteners, or combinations thereof.

The light assembly 104 is not limited to light emitting diodes 106. The light assembly 104 includes any electrically powered light-generating device configured to produce visible light when supplied with electrical power. Non-limiting examples of light-generating devices include light emitting diodes 106, filament-based light sources, electroluminescent elements, fiber-optic light sources, or any other electric illumination device suitable for providing a visible warning indication.

The control assembly 112 is not limited to the specific switch configurations described. The control assembly 112 includes any electrical control component configured to selectively control operation of the light assembly 104. Non-limiting examples include manual switches, toggle switches, push-button switches, pressure-sensitive switches, or combinations thereof.

While the present disclosure provides specific embodiments of the invention, it should be understood that various modifications and substitutions may be made by those skilled in the art without departing from the spirit and scope of the invention. The features described herein are exemplary and are not intended to limit the invention to the precise configurations disclosed.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise. This invention is susceptible to considerable variation within the spirit and scope of the appended claims.

All U.S. patents and publications identified herein are incorporated in their entirety by reference thereto.

The claimed invention is:

1. A warning arrow sign device, comprising:
a hollow cylindrical body formed of braided vinyl tubing, said tubing comprising a plurality of interlaced polymeric strands defining a braided reinforcement pattern forming a tubular wall;
an array of light emitting diodes disposed within a lumen of the hollow cylindrical body; and
a plurality of magnets secured along an interior longitudinal surface of the tubular wall of the hollow cylindrical body for removable magnetic attachment of the warning arrow sign device to a metallic surface of a vehicle.

2. The warning arrow sign device of claim 1, wherein the braided reinforcement pattern comprises a cross-stitch configuration oriented helically about the tubular wall.

3. The warning arrow sign device of claim 1, wherein the hollow cylindrical body is resiliently flexible to conform to a curved surface of the vehicle.

4. The warning arrow sign device of claim 1, wherein the hollow cylindrical body comprises transparent or translucent braided vinyl to permit outward illumination of the light emitting diodes.

5. The warning arrow sign device of claim 1, wherein the magnets comprise neodymium magnets spaced along one side of the hollow cylindrical body.

6. The warning arrow sign device of claim 1, wherein the plurality of interlaced polymeric strands are heat-fused at interstitial crossing points to enhance rigidity.

7. The warning arrow sign device of claim 1, wherein the hollow cylindrical body defines an elongated arrow shaft portion terminating in an arrowhead portion also formed of the braided vinyl tubing.

8. A warning arrow sign device, comprising:
a hollow braided tubular body comprising a plurality of interwoven vinyl strands defining a flexible wall;
a plurality of light emitting diodes disposed within the hollow braided tubular body and arranged in a directional arrow pattern visible through openings defined by the braided vinyl strands;
a power source electrically coupled to the plurality of light emitting diodes; and
a magnet array disposed along a first side of the hollow braided tubular body to facilitate removable magnetic attachment of the device to a metallic surface of a vehicle.

9. The warning arrow sign device of claim 8, wherein the plurality of light emitting diodes are sequentially addressable to generate a moving arrow illumination effect.

10. The warning arrow sign device of claim 8, wherein the power source is housed within a compartment integrated into the hollow braided tubular body.

11. The warning arrow sign device of claim 8, wherein the magnet array is positioned opposite the illuminated direction of the plurality of light emitting diodes.

12. The warning arrow sign device of claim 8, wherein the plurality of light emitting diodes are embedded along an interior support strip extending within the hollow braided tubular body.

13. The warning arrow sign device of claim 8, wherein the hollow braided tubular body is formed as a single continuous piece defining both an arrow shaft portion and an arrowhead portion.

14. The warning arrow sign device of claim 8, wherein the braided vinyl wall includes at least two different polymeric strand diameters to define a textured reinforcement pattern.

15. A warning arrow sign device, comprising:
a hollow cylindrical body comprising braided vinyl tubing having a lumen;
a plurality of light emitting diodes disposed within the lumen of the braided vinyl tubing;
a battery electrically connected to the plurality of light emitting diodes;
a switch electrically interposed between the battery and the plurality of light emitting diodes for selectively energizing the plurality of light emitting diodes; and
a plurality of magnets affixed along a longitudinal side of the hollow cylindrical body for removably securing the warning arrow sign device to a metallic surface of a vehicle.

16. The warning arrow sign device of claim 15, wherein the switch comprises a manual toggle switch mounted externally on the hollow cylindrical body.

17. The warning arrow sign device of claim 15, wherein the switch comprises a pressure-sensitive switch configured to energize the plurality of light emitting diodes upon magnetic attachment of the hollow cylindrical body to the metallic surface.

18. The warning arrow sign device of claim 15, wherein the hollow cylindrical body comprises a diameter between 1.0 cm and 5.0 cm.

19. The warning arrow sign device of claim 15, wherein the plurality of magnets are recessed within magnet housings secured to the braided vinyl tubing.

20. The warning arrow sign device of claim 15, wherein the hollow cylindrical body is bendable into a curved arrow shape while maintaining structural integrity of the braided vinyl strands.

21. The warning arrow sign device of claim 15, wherein the battery comprises a rechargeable lithium-ion cell positioned within the hollow cylindrical body.
